(19) United States
(12) Patent Application Publication
(10) Pub. No.: US 2025/0337559 A1
(43) Pub. Date: Oct. 30, 2025

(54) Secure Storage and Distribution of Docker Images using Homomorphic Encryption and Blockchain

(71) Applicant: Bank of America Corporation, Charlotte, NC (US)

(72) Inventors: Veerendra Gupta, Hyderabad (IN); Simhadri Naidu Velamala, Hyderabad (IN); Atul Dhomne, Hyderabad (IN)

(21) Appl. No.: 18/645,520

(22) Filed: Apr. 25, 2024

(51) Int. Cl. H04L 9/00; H04L 9/06; H04L 9/32; H04L 9/40

(52) U.S. Cl. CPC H04L 9/008; H04L 9/0631; H04L 9/32; H04L 9/50; H04L 63/1433

(57) ABSTRACT

Arrangements for securely storing and distributing docker images are provided. A computing platform may receive a docker image. The computing platform may scan the docker image. The computing platform may generate a CVE list based on identified vulnerabilities and incorporate the CVE list into the docker image. The computing platform may encrypt the docker image and send the docker image to a docker image storage system. The computing platform may create an image BCID and encrypt the image BCID. The computing platform may generate and record metadata associated with the image BCID on a blockchain network.

### BACKGROUND

Applications may be developed using containerization-based technology. For example, a docker image may be a file containing a set of instructions, that when executed, may build a docker container. A docker container may be a software package (that includes, e.g., code, runtime, libraries, etc) that can run an application on any operating system. Currently, storing and distributing a docker image may be subject to security and privacy concerns. Accordingly, it may be advantageous to identify more effective and efficient methods to securely store and distribute docker images.

### SUMMARY

Aspects of the disclosure provide effective, efficient, scalable, and convenient solutions that address and overcome the technical problems associated with securely storing and distributing docker images. In accordance with one or more aspects of the disclosure, a computing platform with at least one processor, a communication interface communicatively coupled to the at least one processor, and memory storing computer-readable instructions may receive a docker image from a user device. The computing platform may scan the docker image, in which the scanning may identify one or more vulnerabilities associated with the docker image. The computing platform may generate a common vulnerabilities and exposures (CVE) list based on the one or more vulnerabilities that were identified by the scanning. The computing platform may incorporate the CVE list into the docker image. The computing platform may encrypt the docker image using a symmetric encryption process. The computing platform may send the encrypted docker image to a docker image storage system and commands that may cause the docker image storage system to store the encrypted docker image. The computing platform may receive a code corresponding to the encrypted docker image from the docker image storage system. The computing platform may create an image blockchain identifier (BCID) based on the code and information corresponding to the user device. The computing platform may encrypt the image BCID using a homomorphic encryption process. The computing platform may generate metadata corresponding to the encrypted image BCID. The computing platform may record the metadata on a blockchain, in which the recording may enhance security of access to the encrypted docker image by providing a layer of authentication using the encrypted image BCID and the corresponding metadata.

In one or more examples, the computing platform may receive, from the user device, a first request to access the docker image. The computing platform may authenticate the user device by matching the encrypted image BCID with the corresponding metadata on the blockchain, and identifying whether the user device has permission to access the encrypted docker image based on the matching. The computing platform may decrypt the encrypted image BCID based on authenticating the user device. The computing platform may send a second request to the docker image storage system, in which the second request may include the code and commands that cause the docker image storage system to send the encrypted docker image that corresponds to the code. The computing platform may receive from the docker image storage system, the encrypted docker image that corresponds to the code. The computing platform may decrypt the encrypted docker image. The computing platform may send to the user device the decrypted docker image.

In some instances, the computing platform may compare a total number of vulnerabilities in the CVE list to a threshold. The computing platform may, based on the total number of vulnerabilities not exceeding the threshold, encrypt the docker image. In one or more examples, the computing platform may compare a total number of vulnerabilities in the CVE list to a threshold. The computing platform may, based on the total number of vulnerabilities meeting or exceeding the threshold, send a notification to the user device.

In some instances, the symmetric encryption process may include an advanced encryption standard (AES) 256. In one or more examples, the code may be an alphanumeric sequence that may identify a location at the docker image storage system where the encrypted docker image is stored. In some instances, the image BCID may be generated using a Fowler-Noll-Vo (FNV) hash algorithm.

In one or more examples, the homomorphic encryption process may include Rivest-Shamir-Adleman (RSA) encryption. In some instances, the metadata may be recorded on the blockchain network using a smart contract, in which the smart contract may define one or more rules that may identify permissioned devices that can access the docker image. In one or more examples, the user device updates permissioned devices that can access the docker image.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for securely storing and distributing docker images using homomorphic encryption and blockchain in accordance with one or more example embodiments;

FIGS. 2A-2F depict an illustrative event sequence for securely storing and distributing docker images using homomorphic encryption and blockchain in accordance with one or more example embodiments;

FIG. 3 depicts an illustrative method for securely storing and distributing docker images using homomorphic encryption and blockchain in accordance with one or more example embodiments;

FIG. 4 depicts an additional illustrative method for securely storing and distributing docker images using homomorphic encryption and blockchain in accordance with one or more example embodiments; and

FIG. 5 depicts an illustrative graphical user interface for securely storing and distributing docker images using homomorphic encryption and blockchain in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to securely storing and distributing docker images. For example, information security may be an important concern in enterprise systems. In modern cloud computing, container-based virtualization technologies may be used to develop applications. Further, the use of docker images has revolutionized application deployment and management. However, ensuring the security of docker images during sharing and transmission may pose significant challenges. These technologies may face security issues, for example, vulnerabilities and malware in docker images and/or docker containers. The risk of privilege escalation may increase because docker images/containers may share a kernel system. As organizations increasingly rely on containerization for application deployment, the need for a secure, decentralized, and privacy-preserving storage solution for docker images may become paramount. Securities challenges may include data confidentiality, data integrity, image tampering, person-in-the-middle attacks, vulnerability disclosure, and data confidentiality.

Accordingly, described herein is an implementation of a distributed system which may be known as a safeguarded docker image distribution system. This innovative system may incorporate the advanced technologies including homomorphic encryption, blockchain and artifactory storage systems (e.g., inter planetary file system), which may ensure the sensitive data within docker images may always remain encrypted even during distribution and storage. This system may safeguard the contents of the images from unauthorized access and potential breaches. This system may involve a combination of techniques to ensure the integrity and authenticity of the docker image.

Accordingly, the system may use highly secure docker image sharing based on blockchain-based and homomorphic encryption-based technologies. The system may use homomorphic encryption to offer authentication and access control to metadata for secure docker image sharing. The system structure for secure docker image sharing may be implemented for the docker image, ensuring integrity using the artifactory storage system. This system may give priority to features such as secure docker image upload, secure docker image sharing, and secure docker image download. Secure docker images may be uploaded to the artifactory storage system, which may prevent unauthorized users from accessing the data contained within the secure docker images.

These and other features are described in greater detail below.

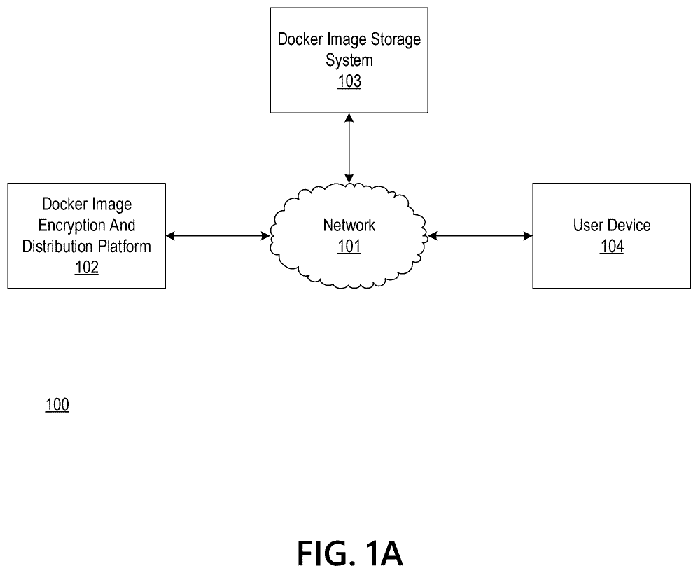

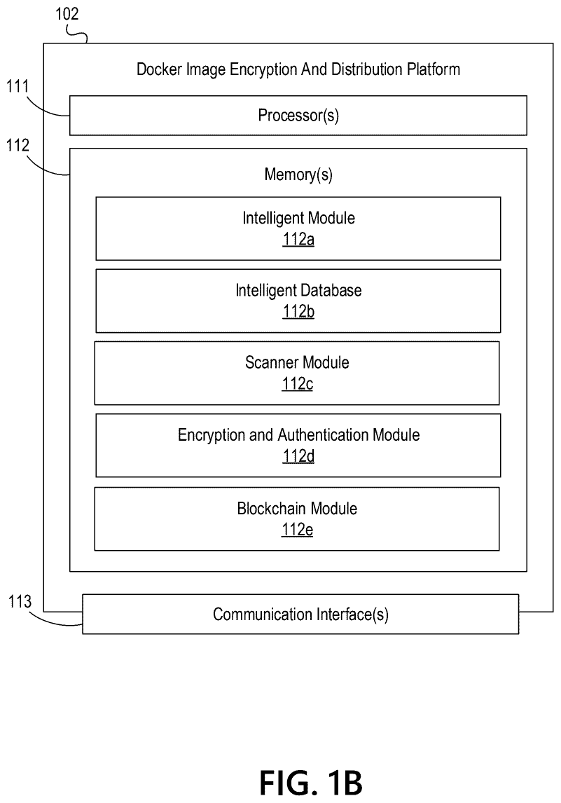

FIGS. 1A-1B depict an illustrative computing environment for securely storing and distributing docker images using homomorphic encryption and blockchain in accordance with one or more example embodiments. Referring to FIG. 1A, computing environment 100 may include one or more computer systems. For example, computing environment 100 may include a docker image encryption and distribution platform 102, docker image storage system 103, and a user device 104.

As described further below, docker image encryption and distribution platform 102 may be a computer system that includes one or more computing devices (e.g., servers, server blades, or the like) and/or other computer components (e.g., processors, memories, communication interfaces) that may be used to receive and/or encrypt a docker image, create and/or encrypt an image blockchain identifier (BCID), and/or perform other functions. In some instances, docker image encryption and distribution platform 102 may further be used to host, configure, and/or otherwise update a blockchain network, which may be used to record metadata corresponding to an image BCID, and/or perform other functions.

Docker image storage system 103 may be or include one or more computing devices (e.g., servers, server blades, or the like) and/or computer components (e.g., processors, memories, communication interfaces, and/or other components). In some instances, enterprise storage system 103 may include one or more data sources that may store an encrypted docker image, as discussed in more detail below. In some instances, docker image storage system 103 may be configured as a cloud storage system, in which docker image storage system 103 may be a cloud computing model that stores data on the Internet through a cloud computing provider who manages and operates docker image storage system 103 as a service. In some instances, enterprise storage system 103 may be local or non-cloud based storage, or may support cloud based storage.

User device 104 may be a laptop computer, desktop computer, mobile device, tablet, smartphone, and/or other device, which may correspond to an application developer who may create a docker image. In some instances, user device 104 may be a user computing device that is used by an individual. In some instances, user device 104 may be an enterprise computing device that is used by an administrator. In some instances, user device 104 may be configured to display one or more user interfaces (e.g., interfaces depicting that metadata corresponding to an image BCID was recorded on a blockchain, or the like). Although only a single user device 104 is depicted, this is for illustrative purposes only, and any number of user devices may be implemented in the environment 100 without departing from the scope of the disclosure.

Computing environment 100 also may include one or more networks, which may include docker image encryption and distribution platform 102, docker image storage system 103, and user device 104. For example, computing environment 100 may include a network 101 (which may interconnect, e.g., docker image encryption and distribution platform 102, docker image storage system 103, and user device 104, and/or other computing devices).

In one or more arrangements, docker image encryption and distribution platform 102, docker image storage system 103, and user device 104 may be any type of computing device capable of sending and/or receiving requests and processing the requests accordingly. For example, docker image encryption and distribution platform 102, docker image storage system 103, and user device 104, and/or the other systems included in computing environment 100 may, in some instances, be and/or include, server computers, desktop computers, laptop computers, tablet computers, smart phones, or the like that may include one or more processors, memories, communication interfaces, storage devices, and/or other components. As noted above, and as illustrated in greater detail below, any and/or all of docker image encryption and distribution platform 102, docker image storage system 103, and user device 104 may, in some instances, be special-purpose computing devices configured to perform specific functions.

Referring to FIG. 1B, docker image encryption and distribution platform 102 may include one or more processors 111, memory 112, and communication interface 113. A data bus may interconnect processor 111, memory 112, and communication interface 113. Communication interface 113 may be a network interface configured to support communication between docker image encryption and distribution platform 102 and one or more networks (e.g., network 101, or the like). Memory 112 may include one or more program modules having instructions that when executed by processor 111 cause docker image encryption and distribution platform 102 to perform one or more functions described herein and/or one or more databases that may store and/or otherwise maintain information which may be used by such program modules and/or processor 111. In some instances, the one or more program modules and/or databases may be stored by and/or maintained in different memory units of docker image encryption and image distribution platform 102, docker image storage system 103, user device 104, and/or by different computing devices that may form and/or otherwise make up docker image encryption and distribution platform 102, docker image storage system 103, and user device 104. For example, memory 112 may have, host, store, and/or otherwise include intelligent module 112a, intelligent database 112b, scanner module 112c, encryption and authentication module 112d, and/or blockchain module 112e.

Intelligent module 112a may have instructions that direct and/or cause docker image encryption and distribution platform 102 to receive a docker image, receive a request to decrypt an encrypted image BCID and/or encrypted docker image, and/or perform other functions. Intelligent database 112b may store information used by the intelligent module 112a and/or docker image encryption and distribution platform 102 in application of techniques to securely store and/or distribute docker images, and/or perform other functions. Scanner module 112c may be configured and/or used by docker image and distribution platform 102 and/or intelligent module 112a to scan a docker image, identify one or more vulnerabilities based on the scanning, generate a common vulnerabilities and exposures (CVE) list based on the identified vulnerabilities, and/or perform other functions. Encryption and authentication module 112d may be configured and/or used by docker image encryption and distribution platform 102 to encrypt/decrypt a docker image, encrypt/decrypt an image BCID, and/or perform other functions. Blockchain module 112e may be configured and/or used by docker image encryption and distribution platform 102 to host, maintain, and/or otherwise modify a blockchain network that may record metadata corresponding to an image BCID, and/or perform other functions.

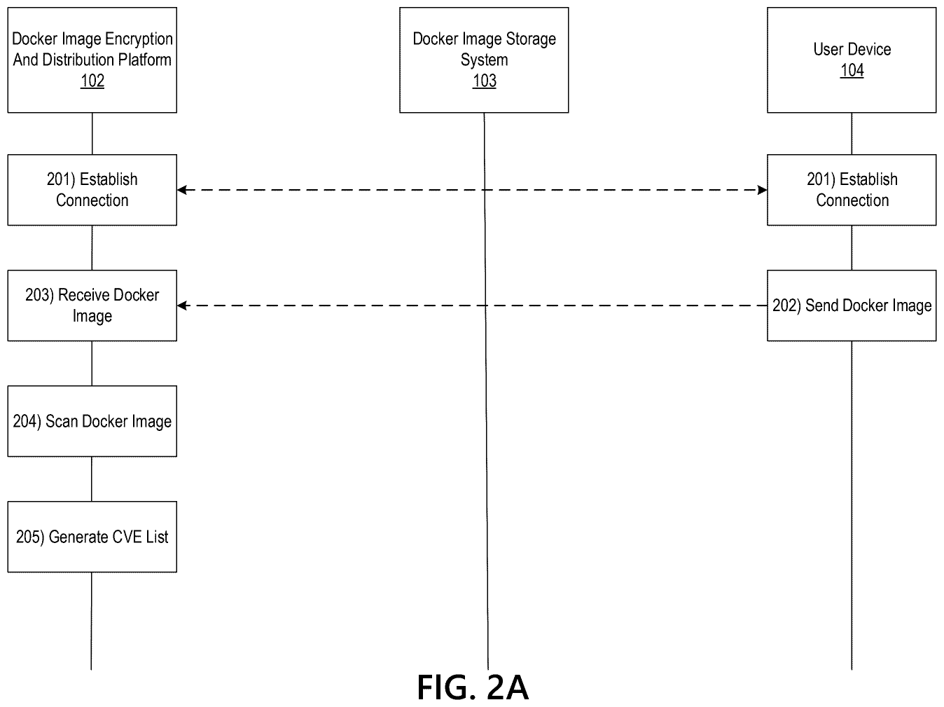

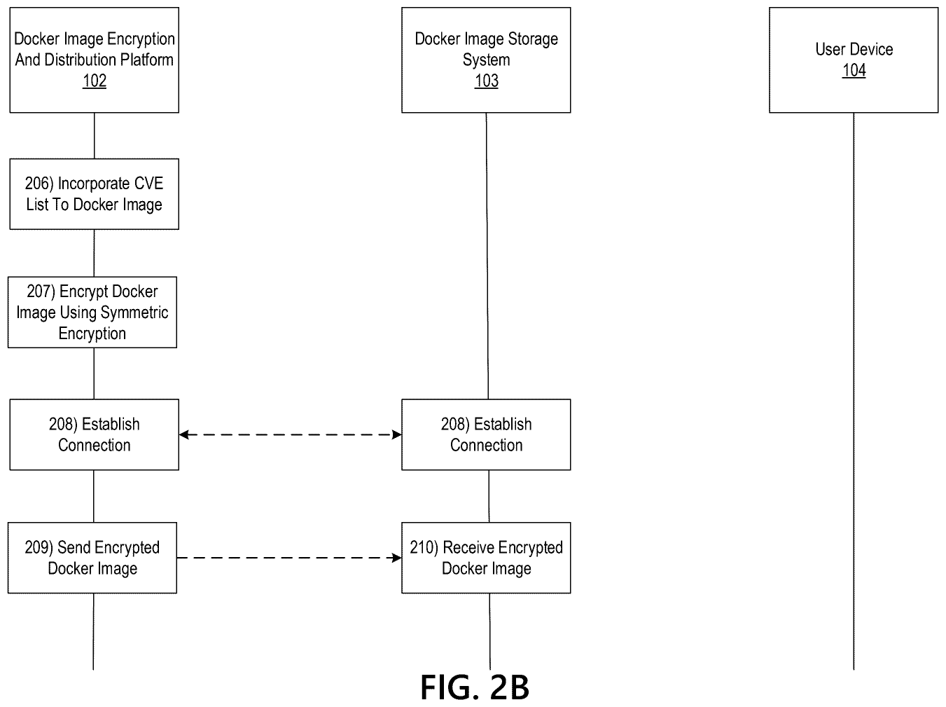

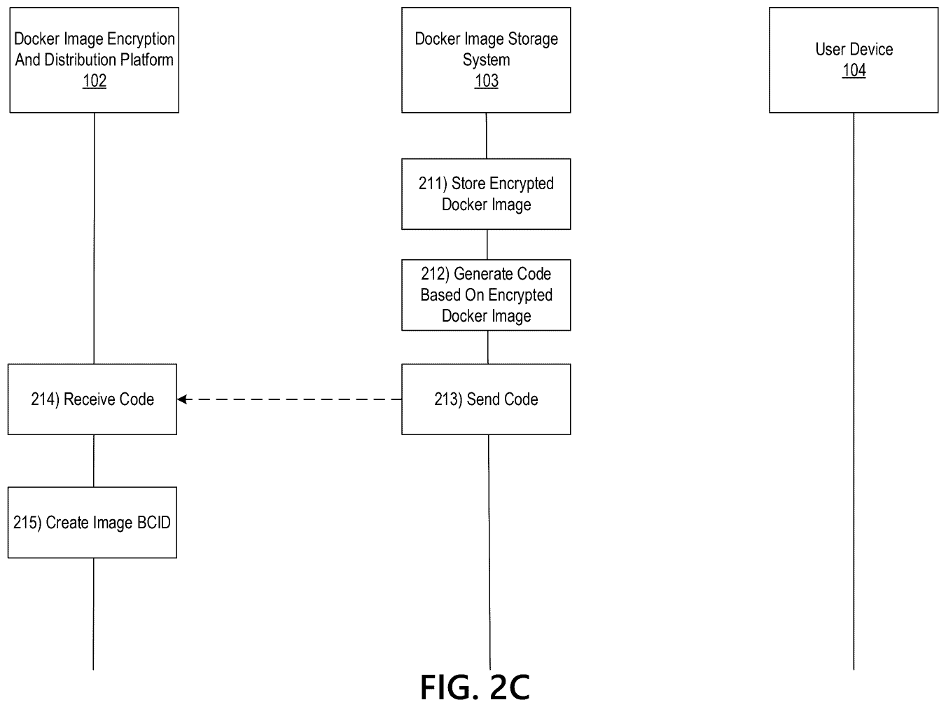

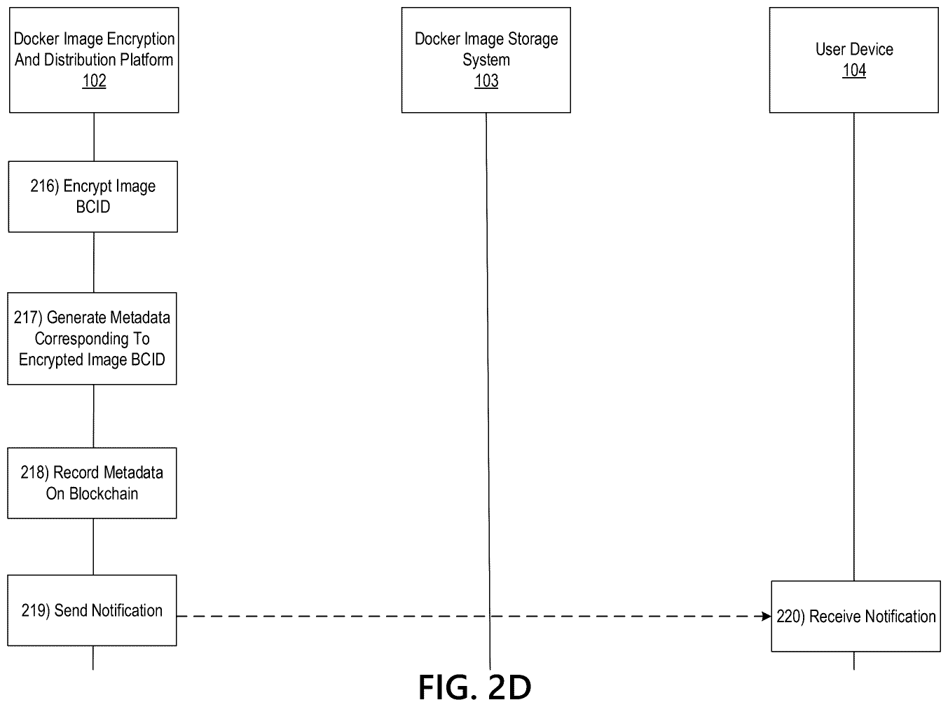

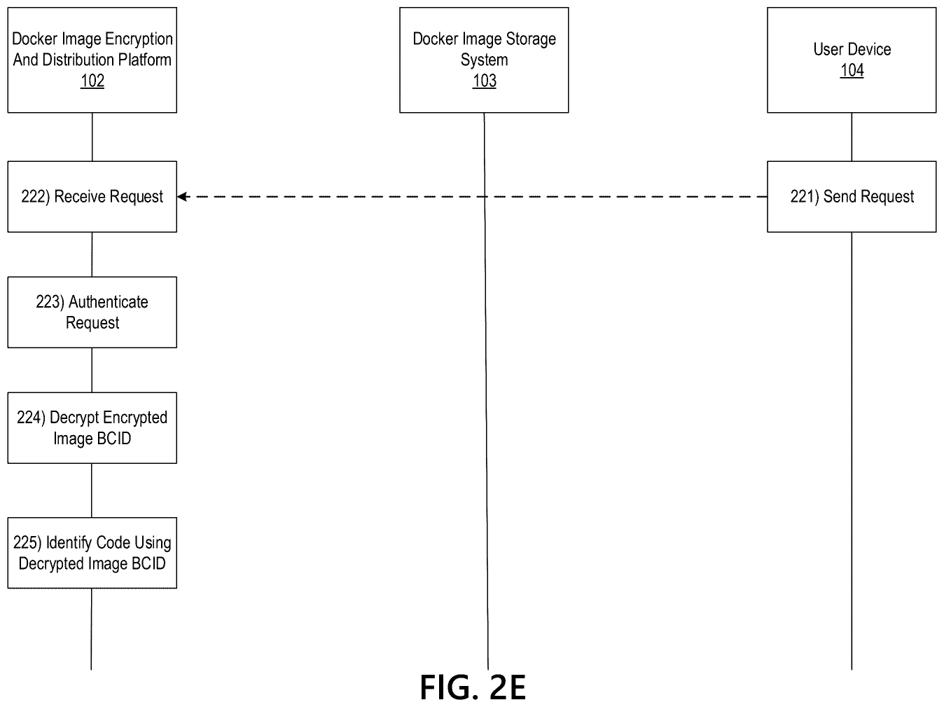

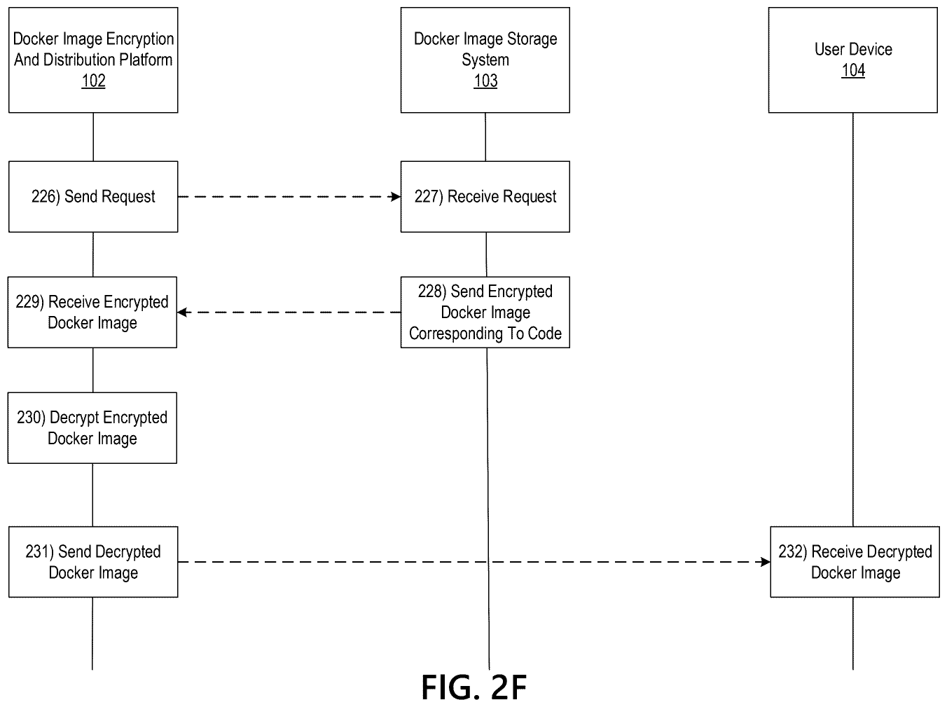

FIGS. 2A-2F depict an illustrative event sequence for securely storing and distributing docker images using homomorphic encryption and blockchain in accordance with one or more example embodiments. Referring to FIG. 2A, at step 201, user device 104 may establish a connection with docker image encryption and distribution platform 102. For example, user device 104 may establish a first wireless data connection with docker image encryption and distribution platform 102 to link user device 104 to docker image encryption and distribution platform 102 (e.g., in preparation for sending a docker image). In some instances, user device 104 may identify whether or not a connection is already established docker image encryption and distribution platform 102. If a connection is already established with docker image encryption and distribution platform 102, user device 104 might not re-establish the connection. If a connection is not already established with docker image encryption and distribution platform 102, user device 104 may establish the first wireless data connection as described herein.

At step 202, user device 104 may send a docker image to docker image encryption and distribution platform 102. For example, user device 104 may send the docker image to docker image encryption and distribution platform 102 while the first wireless data connection is established. In some instances, the docker image may contain a set of instructions that, when executed, may create a docker container, which may be a software package (that includes, e.g., code, runtime, libraries, etc) that may run an application on any operating system.

At step 203, docker image encryption and distribution platform 102 may receive the docker image. For example, the docker image encryption and distribution platform 102 may receive the docker image via the communication interface 113 and while the first wireless data connection is established.

At step 204, docker image encryption and distribution platform 102 may scan the docker image that was previously received in step 203. In scanning the docker image, docker image encryption and distribution platform 102 may identify one or more vulnerabilities associated with the docker image. For example, in identifying the one or more vulnerabilities, the docker image encryption and distribution platform 102 may identify, for example, security issues that may allow malicious actors to exploit the docker image, privacy concerns, or the like. In some instances, a database of known vulnerabilities may be used by docker image encryption and distribution platform 102 as a reference to identify the one or more vulnerabilities during the scanning.

At step 205, docker image encryption and distribution platform 102 may generate a common vulnerabilities and exposures (CVE) list based on the scanning performed in step 204 and the one or more vulnerabilities that were previously identified as part of the scanning. In some instances, docker image encryption and distribution platform 102 may take the previously identified vulnerabilities, and categorize and/or rank the vulnerabilities based on how serious the vulnerabilities are, as part of generating the CVE list. For example, docker image encryption and distribution platform 102 may perform the ranking by scoring the vulnerabilities on a 1-5 point scale of increasing seriousness, in which a lower number (i.e., 1) may represent a vulnerability of lower concern and a higher number (e.g., 5) may represent a vulnerability of higher concern.

In some instances, docker image encryption and distribution platform 102 may compare the number of identified vulnerabilities in the CVE list to the threshold, and, based on the threshold not being met or exceeded (representing, e.g., that the docker image is secure), continue to step 206. Otherwise, if the docker image encryption and distribution platform 102 identifies that the threshold is met or exceeded (representing, e.g., that the docker image is not secure), the image encryption and distribution platform 102 might not move forward with the below steps. Rather, the docker image encryption and distribution platform 102 may instead notify user device 104 that the docker image might not be secure enough and may need additional analysis and/or modification.

Referring to FIG. 2B, at step 206, docker image encryption and distribution platform 102 may incorporate the CVE list into the docker image. In incorporating the CVE list to the docker image, docker image encryption and distribution platform 102 may add a comment or make a notation in the docker image of the one or more previously identified vulnerabilities that makeup the CVE list. In some instances, in incorporating the CVE list to the docker image, docker image encryption and distribution platform 102 may create and add a file to the docker image that contains the CVE list. In some instances, all the previously identified vulnerabilities may be included. Additionally or alternatively, vulnerabilities above a certain score (i.e., greater than 3) may be included. Any number of combinations may be used without departing from the scope of the disclosure.

At step 207, docker image encryption and distribution platform 102 may encrypt the docker image using a symmetric encryption process. For example, advanced encryption standard (AES) 256 may be used, in which docker image encryption and distribution platform 102 may use encryption and authentication module 112d to create a 256-bit encryption key to convert the docker image into encrypted cipher text. In some instances, the encryption key itself may be encrypted using a similar encryption method. Although described with respect to AES-256 encryption, docker image encryption and distribution platform 102 may use other forms of symmetric encryption (e.g., data encryption standard (DES), triple data encryption standard (3DES), or the like) without departing from the scope of the disclosure.

At step 208, docker image encryption and distribution platform 102 may establish a connection with docker image storage system 103. For example, docker image encryption and distribution platform 102 may establish a second wireless data connection with docker image storage system 103 to link docker image encryption and distribution platform 102 to docker image storage system (e.g., in preparation for sending the encrypted docker image). In some instances, docker image encryption and distribution platform 102 may identify whether or not a connection is already established with docker image storage system 103. If a connection is already established with docker image storage system 103, docker image encryption and distribution platform 102 might not re-establish the connection. If a connection is not already established with docker image storage system 103, docker image encryption and distribution platform 102 may establish the second wireless data connection as described herein.

At step 209, docker image encryption and distribution platform 102 may send the encrypted docker image to docker image storage system 103. For example, docker image encryption and distribution platform 102 may send the encrypted docker image to docker image storage system 103 while the second wireless data connection is established. In some instances, docker image storage system 103 may be an artifactory and/or storage system that may store a plurality of encrypted docker images from a plurality of user devices. In some instances, docker image storage system 103 may be, for example, an interplanetary file system (IPFS), a JFrog artifactory, or the like.

At step 210, docker image storage system 103 may receive the encrypted docker image that was sent in step 209. For example, docker image storage system 103 may receive the encrypted docker image while the second wireless data connection is established. In some instances, docker image storage system 103 may also receive commands from docker image encryption and distribution platform 102, that when received by docker image storage system 103, may direct docker image storage system 103 to store the encrypted docker image.

Referring to FIG. 2C, at step 211, docker image storage system 103 may store the encrypted docker image. In some instances, the storing may be based on the commands that were sent by docker image encryption and distribution platform 102. At step 212, docker image storage system 103 may generate a code based on the stored encrypted docker image. For example, in generating the code, docker image storage system 103 may generate an alphanumeric sequence that identifies a location (i.e., an address) where the stored encrypted docker image may be located at the docker image storage system 103.

At step 213, docker image storage system 103 may send the code to docker image encryption and distribution platform 102. For example, docker image storage system 103 may send the code using the previously established second wireless data connection. In some instances, the sending may be based on the commands that were received from docker image encryption and distribution platform 102 at step 210 and after the encrypted docker image was stored at step 211.

At step 214, docker image encryption and distribution platform 102 may receive the code that was sent by docker image storage system 103 at step 213. For example, the docker image encryption and distribution platform 102 may receive the code via the communication interface 113 and while the second wireless data connection is established.

At step 215, docker image encryption and distribution platform 102 may create an image blockchain identifier (BCID). For example, in creating the image BCID, docker image encryption and distribution platform 102 may hash together the previously received code (e.g., received at step 214 and that corresponds to the location where the encrypted docker image is stored at docker image storage system 103) and other information, such as information about user device 104, information about the docker image (e.g., the size or other parameters/characteristics of the docker image), and/or other types of similar information. In some instances, docker image encryption and distribution platform 102 may use a Fowler-Noll-Vo (FNV) hash algorithm to create the image BCID.

Referring to FIG. 2D, at step 216, docker image encryption and distribution platform 102 may encrypt the image BCID. In some instances, docker image encryption and distribution platform 102 may utilize a homomorphic encryption process to encrypt the image BCID. For example, docker image encryption and distribution platform 102 may encrypt the image BCID using a Rivest-Shamir-Adleman (RSA) encryption algorithm. Although described with respect to an RSA encryption algorithm, other homomorphic and/or asymmetric encryption methods (e.g., Diffie-Hellman, Elliptic Curve Cryptography (ECC), or the like) may be used without departing from the scope of the disclosure. In utilizing homomorphic encryption, docker image encryption and distribution platform 102 may perform mathematical/cryptographic operations on encrypted data, that when decrypted, retains the operations that were previously performed.

At step 217, docker image encryption and distribution platform 102 may generate metadata corresponding to the encrypted image BCID. In generating the metadata, docker image encryption and distribution platform 102 may generate information that identifies one or more permissioned devices (e.g., user device 104 or other devices), that may have permission to access the encrypted image BCID and/or the encrypted docker image. In some instances, user device 104 may determine the one or more other permissioned devices. In some instances, docker image encryption and distribution platform 102 may determine the permissioned devices based on, for example, the role of a device within an enterprise organization (although the determination of permissioned devices may be based on different considerations without departing from the scope of the disclosure).

At step 218, docker image encryption and distribution platform 102 may record the metadata on the blockchain (at, e.g., blockchain module 112e). In recording the metadata on the blockchain, docker image encryption and distribution platform 102 may create an immutable record that may be used to determine whether one or more devices (e.g., user device 104) may have permission to request and/or access a docker image that corresponds to an image BCID. Although described with respect to a docker image that was created by user device 104, a plurality of docker images created by a plurality of devices may similarly be used to create an image BCID, generate corresponding metadata, and record the corresponding metadata on the blockchain. In some instances, a smart contract may used to record the metadata on the blockchain, in which, for example, the smart contract may execute one or more rules to identify one or more permissioned devices that may request and/or access a previously stored encrypted docker image. In recording metadata corresponding to an encrypted image BCID on a blockchain, docker image encryption and distribution platform 102 may provide a higher level of security and/or authentication due to the immutable and private nature of the blockchain. In some instances, step 218 may include modifying, adding, and/or otherwise changing recorded metadata on the blockchain without departing from the scope of the disclosure.

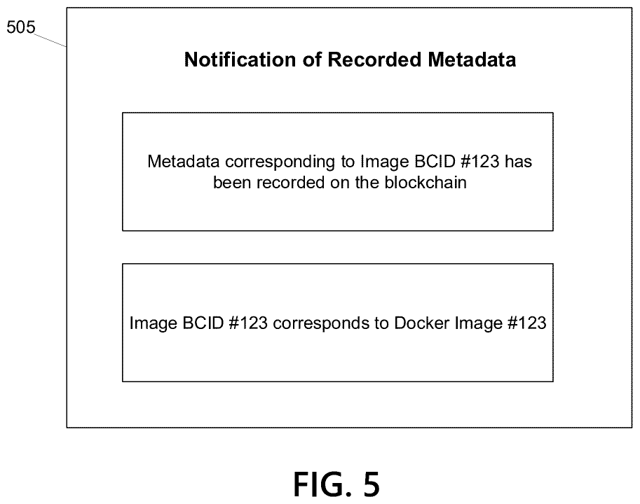

At step 219, docker image encryption and distribution platform 102 may send a notification to the user device 104. For example, docker image encryption and distribution platform 102 may send the notification using the previously established second wireless data connection. In some instances, the notification may also include commands that, when received by user device 104, may cause user device 104 to display the notification. In some instances, the notification may be similar to the graphical user interface 505 depicted in FIG. 5. For example, the notification may include an indication that metadata corresponding to an image BCID has been recorded, and that the image BCID corresponds to the previously stored docker image, and/or other similar information.

At step 220, user device 104 may receive the notification. For example, user device 104 may receive the notification while the first wireless data connection is established.

The previous steps 201-220 may describe how docker image encryption and distribution platform 102 may receive, encrypt, and securely store a docker image. The following steps 221-232 may describe how docker image encryption and distribution platform 102 may securely distribute a docker image to user device 104 and/or other permissioned devices.

Referring to FIG. 2E, at step 221, user device 104 may send a request to docker image encryption image and distribution platform 102 to access the docker image that was previously encrypted and stored at docker image storage system 103. For example, user device 104 may send the request using the previously established first wireless data connection. In some instances, the request may include information that identifies user device 104 as being the source of the request.

At step 222, docker image encryption and distribution platform 102 may receive the request. For example, the docker image encryption and distribution platform 102 may receive the request via the communication interface 113 and while the first wireless data connection is established.

At step 223, docker image encryption and distribution platform 102 may authenticate the request by using the information in the request that identifies user device 104 as being the source of the request. Subsequently, docker image encryption and distribution platform 102 may determine whether user device 104 has permission to access the encrypted docker image by matching the metadata that was stored in the blockchain to the corresponding encrypted image BCID, which itself corresponds to the encrypted docker image.

In some instances, if a device is not authenticated, then a notification may be sent to user device 104 that a device attempted and failed to access the docker image. In some instances, if multiple attempts are made to access the docker image that are not authenticated, docker image encryption and distribution platform 102 might not allow any device to attempt to access the docker image for a period of time. If the device is authenticated, docker image encryption and distribution platform 102 may proceed to step 224 and decrypt the encrypted image BCID. In some instances, results related to the authentication performed in step 223 may be recorded on the blockchain.

At step 224, docker image encryption and distribution platform 102 may decrypt the encrypted image BCID. For example, docker image encryption and distribution platform 102 may decrypt the encrypted image BCID by reversing the previously used homomorphic encryption method (e.g., the RSA encryption in step 216).

At step 225, docker image encryption and distribution platform 102 may identify the code using the decrypted image BCID. For example, by decrypting the encrypted image BCID, docker image encryption and distribution platform 102 may reveal the code that was hashed to create the image BCID (as described in step 215).

Referring to FIG. 2F, at step 226, docker image encryption and distribution platform 102 may send a request to docker image storage system 103 to provide the encrypted docker image that corresponds to the decrypted image BCID. For example, docker image encryption and distribution platform 102 may send the request using the previously established first wireless data connection and via communicate interface 113. In some instances, the request may include the code (that was generated in step 212) and commands, that when received by docker image storage system 103, direct docker image storage system 103 to send the previously stored encrypted docker image that corresponds to the code to docker image encryption and distribution platform 102.

At step 227, docker image storage system 103 may receive the request. For example, docker image storage system 103 may receive the request while the second wireless data connection is established.

At step 228, docker image storage system 103 may send the encrypted docker image that corresponds to the code in the request (because, e.g., the code corresponds to the location where the encrypted docker image is located at docker image storage system 103). For example, docker image storage system 103 may send the encrypted docker image while the second wireless data connection is established.

At step 229, docker image encryption and distribution platform 102 may receive the encrypted docker image. For example, the docker image encryption and distribution platform 102 may receive the encrypted docker image via the communication interface 113 and while the second wireless data connection is established.

At step 230, docker image encryption and distribution platform 102 may decrypt the encrypted docker image. For example, docker image encryption and distribution platform 102 may decrypt the encrypted docker image by reversing the previously used symmetric encryption method (e.g., using the AES-256 encryption key to decrypt the encrypted docker image).

At step 231, docker image encryption and distribution platform 102 may send the decrypted docker image to user device 104. For example, the docket image encryption and distribution platform 102 may send the decrypted docker image via the communication interface 113 and while the first wireless data connection is established.

At step 232, user device 104 may receive the decrypted docker image. For example, user device 104 may receive the decrypted docker image while the first wireless data connection is established.

Because docker image encryption and distribution platform 102 may utilize separate encryption methods for the storage and distribution of docker images, and further record information about permissioned devices that may request and/or access the docker image in a blockchain, docker image encryption and distribution platform 102 enhances the security of access to docker images by providing an additional layer of authentication using the encrypted image BCID and recording corresponding metadata (that identifies, e.g., permissioned devices) on the blockchain.

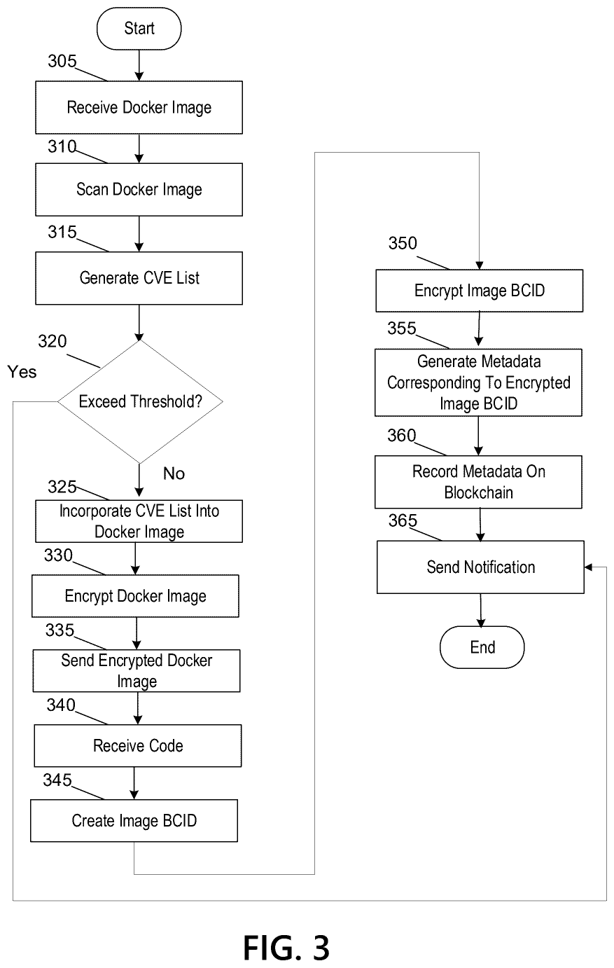

FIG. 3 depicts an illustrative method for securely storing and distributing docker images using homomorphic encryption and blockchain in accordance with one or more example embodiments. At step 305, a computing platform having at least one processor, a communication interface, and memory may receive a docker image from user device 104. At step 310, the computing platform may scan the docker image. At step 315, the computing platform may generate a common vulnerabilities and exposure (CVE) list based on one or more vulnerabilities that were identified by the scanning performed in step 310.

At step 320, the computing platform may compare the total number of vulnerabilities in the CVE list to a threshold. If the total number of vulnerabilities meets or exceeds a threshold, then the method may proceed to step 365. If the total number of vulnerabilities does not meet or exceed the threshold, then the method may proceed to step 325.

At step 325, the computing platform may incorporate the CVE list into the docker image. At step 330, the computing platform may encrypt the docker image. At step 335, the computing platform may send the encrypted docker image to docker image storage system 103.

At step 340, the computing platform may receive a code from docker image storage system 103 that corresponds to the encrypted docker image. At step 345, the computing platform may create an image blockchain identifier (BCID) based on the code and information corresponding to user device 104 and the docker image.

At step 350, the computing platform may encrypt the image BCID. At step 355, the computing platform may generate metadata corresponding to the encrypted image BCID. At step 360, the computing platform may record the metadata on a blockchain. At step 365, the computing platform may send a notification to user device 104.

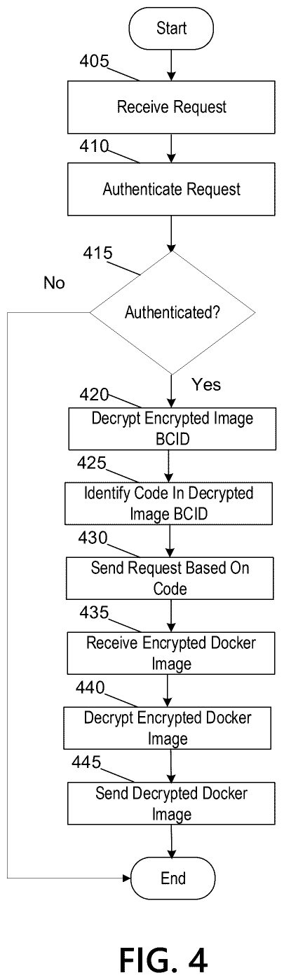

FIG. 4 depicts an illustrative method for securely storing and distributing docker images using homomorphic encryption and blockchain in accordance with one or more example embodiments. At step 405, a computing platform having at least one processor, a communication interface, and memory may receive a request from user device 104 to access a docker image.

At step 410, the computing platform may authenticate the request from user device 104. At step 415, the computing platform may determine whether the request has been authenticated. If the request is not authenticated, the method may proceed to the end. If the request is authenticated, the method may proceed to step 420.

At step 420, the computing platform may decrypt the encrypted image BCID. At step 425, the computing platform may identify the code in the decrypted image BCID. At step 430, the computing platform may send a request to docker image storage system 103 using the previously identified code to receive the corresponding encrypted docker image.

At step 435, the computing platform may receive the encrypted docker image that corresponds to the code from docker image storage system 103. At step 440, the computing platform may decrypt the encrypted docker image. At step 445, the computing platform may send the decrypted docker image to user device 104.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive a docker image from a user device;
scan the docker image, wherein the scanning identifies one or more vulnerabilities associated with the docker image;
generate a common vulnerabilities and exposures (CVE) list based on the one or more vulnerabilities that were identified by the scanning;
incorporate the CVE list into the docker image;
encrypt the docker image using a symmetric encryption process;
send, to a docker image storage system, the encrypted docker image and commands, that when received by the docker image storage system, cause the docker image storage system to store the encrypted docker image;
receive a code corresponding to the encrypted docker image from the docker image storage system;
create an image blockchain identifier (BCID) based on the code and information corresponding to the user device;
encrypt the image BCID using a homomorphic encryption process;
generate metadata corresponding to the encrypted image BCID; and
record the metadata on a blockchain, wherein the recording enhances security of access to the encrypted docker image by providing a layer of authentication using the encrypted image BCID and the corresponding metadata.

2. The computing platform of claim 1, wherein the memory stores computer-readable instructions that, when executed by the at least one processor, further cause the computing platform to:
receive, from the user device, a first request to access the docker image;
authenticate the user device by:
matching the encrypted image BCID with the corresponding metadata on the blockchain, and
identifying whether the user device has permission to access the encrypted docker image based on the matching;
decrypt the encrypted image BCID based on authenticating the user device;
identify the code using the decrypted image BCID;
send a second request to the docker image storage system, wherein the second request includes the code and commands, that when executed by the docker image storage system, cause the docker image storage system to send the encrypted docker image that corresponds to the code;
receive, from the docker image storage system, the encrypted docker image that corresponds to the code;
decrypt the encrypted docker image; and
send, to the user device, the decrypted docker image.

3. The computing platform of claim 1, wherein the memory stores computer-readable instructions that, when executed by the at least one processor, further cause the computing platform to:
compare a total number of vulnerabilities in the CVE list to a threshold; and
based on the total number of vulnerabilities not exceeding the threshold, encrypt the docker image.

4. The computing platform of claim 1, wherein the memory stores computer-readable instructions that, when executed by the at least one processor, further cause the computing platform to:
compare a total number of vulnerabilities in the CVE list to a threshold; and
based on the total number of vulnerabilities meeting or exceeding the threshold, send a notification to the user device.

5. The computing platform of claim 1, wherein the symmetric encryption process comprises advanced encryption standard (AES) 256.

6. The computing platform of claim 1, wherein the code is an alphanumeric sequence that identifies a location at the docker image storage system where the encrypted docker image is stored.

7. The computing platform of claim 1, wherein the image BCID is generated using a Fowler-Noll-Vo (FNV) hash algorithm.

8. The computing platform of claim 1, wherein the homomorphic encryption process comprises Rivest-Shamir-Adleman (RSA) encryption.

9. The computing platform of claim 1, wherein the metadata is recorded on the blockchain network using a smart contract, wherein the smart contract defines one or more rules that identify permissioned devices that can access the docker image.

10. The computing platform of claim 1, wherein the user device updates permissioned devices that can access the docker image.

11. A method comprising:
at a computing platform comprising at least one processor, a communication interface, and memory:
receiving a docker image from a user device;
scanning the docker image, wherein the scanning identifies one or more vulnerabilities associated with the docker image;
generating a common vulnerabilities and exposures (CVE) list based on the one or more vulnerabilities that were identified by the scanning;
incorporating the CVE list into the docker image;
encrypting the docker image using a symmetric encryption process;
sending, to a docker image storage system, the encrypted docker image and commands, that when received by the docker image storage system, cause the docker image storage system to store the encrypted docker image;
receiving a code corresponding to the encrypted docker image from the docker image storage system;
creating an image blockchain identifier (BCID) based on the code and information corresponding to the user device;
encrypting the image BCID using a homomorphic encryption process;
generating metadata corresponding to the encrypted image BCID; and
recording the metadata on a blockchain network, wherein the recording enhances security of access to the encrypted docker image by providing a layer of authentication using the encrypted image BCID and the corresponding metadata.

12. The method of claim 11, further comprising:
receiving, from the user device, a first request to access the docker image;
authenticating the user device by:
matching the encrypted image BCID with the corresponding metadata on the blockchain, and
identifying whether the user device has permission to access the encrypted docker image based on the matching;
decrypting the encrypted image BCID based on authenticating the user device;
identifying the code using the decrypted image BCID;
sending a second request to the docker image storage system, wherein the second request includes the code and commands, that when executed by the docker image storage system, cause the docker image storage system to send the encrypted docker image that corresponds to the code;
receiving, from the docker image storage system, the encrypted docker image that corresponds to the code;
decrypting, the encrypted docker image; and
sending, to the user device, the decrypted docker image.

13. The method of claim 11, wherein the symmetric encryption process comprises advanced encryption standard (AES) 256.

14. The method of claim 11, wherein the code is an alphanumeric sequence that identifies a location at the docker image storage system where the encrypted docker image is stored.

15. The method of claim 11, wherein the image BCID is generated using a Fowler-Noll-Vo (FNV) hash algorithm.

16. The method of claim 11, wherein the homomorphic encryption process comprises Rivest-Shamir-Adleman (RSA) encryption.

17. The method of claim 11, wherein the metadata is recorded on the blockchain network using a smart contract, wherein the smart contract defines one or more rules that determines permissioned devices that can access the docker image.

18. The method of claim 11, wherein the user device updates permissioned devices that can access to the docker image.

19. The method of claim 11, further comprising:
comparing a total number of vulnerabilities in the CVE list to a threshold; and
based on the total number of vulnerabilities meeting or exceeding the threshold, send a notification to the user device.

20. One or more non-transitory computer-readable media storing instructions that, when executed by a computing platform comprising at least one processor, a communication interface, and memory, cause the computing platform to:
receive a docker image from a user device;
scan the docker image, wherein the scanning identifies one or more vulnerabilities associated with the docker image;
generate a common vulnerabilities and exposures (CVE) list based on the one or more vulnerabilities that were identified by the scanning;
incorporate the CVE list into the docker image;
encrypt the docker image using a symmetric encryption process;
send, to a docker image storage system, the encrypted docker image and commands, that when received by the docker image storage system, cause the docker image storage system to store the encrypted docker image;
receive a code corresponding to the encrypted docker image from the docker image storage system;
create an image blockchain identifier (BCID) based on the code and information corresponding to the user device;
encrypt the image BCID using a homomorphic encryption process;
generate metadata corresponding to the encrypted image BCID; and
record the metadata on a blockchain network, wherein the recording enhances security of access to the encrypted docker image by providing a layer of authentication using the encrypted image BCID and the corresponding metadata.
